(19) United States
(12) Patent Application Publication
(10) Pub. No.: US 2006/0110237 A1
(43) Pub. Date: May 25, 2006

(54) Spline drive fastener system

(76) Inventor: Richard Belinda, Westfield, MA (US)

Correspondence Address: ALIX YALE & RISTAS LLP, 750 MAIN STREET, SUITE 1400, HARTFORD, CT, 06103, US

(21) Appl. No.: 11/185,377

(22) Filed: Jul. 20, 2005

Related U.S. Application Data
(60) Provisional application No. 60/630,451, filed on Nov. 23, 2004.

(51) Int. Cl. F16B 23/00

(52) U.S. Cl. 411/403

(57) ABSTRACT

A spline drive fastener system involves a fastener wherein a drive engagement surface is formed in the head of the fastener. The drive engagement surface includes eight separate points of engagement. The points of engagement are arranged on eight radial slots formed by the central axis of the fastener head. A method of forming the drive engagement surface comprises forcing a punch against a fastener workpiece to form at least eight radial slots.

### CROSS-REFERENCE TO RELATED APPLICATION

This application claims the priority of U.S. Application No. 60/630,451 filed on Nov. 23, 2004.

### FIELD OF THE INVENTION

This invention relates generally to fasteners used in the construction arts, and in particular, to fasteners having drive surfaces.

### BACKGROUND OF THE INVENTION

Commercial and residential structures are typically constructed with a variety of fastener types. Typically these fasteners have a head configured to receive a tool for the purpose of allowing the fastener to be driven into an appropriate substrate. Conventionally, the tool receiving portion of the fastener head includes recessed areas which form slots or cavities. The slots are generally either a single slot, formed across the surface of the head, or a pair of intersecting slots which form a cross. In some cases, the fastener head includes a cavity in the form of a square.

Conventionally, a tool having a complementary shape to portions of the fastener head is used to engage the fastener recess. Once received by the recess, the fastener can then be rotated, or otherwise manipulated by the tool, such that the fastener is driven into the material to be secured.

The conventional fastener head and driving tool arrangement suffers from several drawbacks. For example, fasteners are often installed using a tool fitted to a power driver device, such as, an electric drill. This power driven device/tool/fastener combination must be maintained in precise alignment wherein the central axis of the fastener and the central axis of the tool are in angular alignment. In addition, pressure must be applied on the power driver device in order to keep the tool engaged with the fastener and to prevent the tool from “camming out” of the fastener. Typically, if the tool and fastener become misaligned and/or if pressure is not applied to the power driven device, the tool and the fastener head can become fully or partially disengaged. Disengagement is often facilitated by the configuration of the fastener head and tool interface. For instance, the slotted or cross slotted fastener heads often have a configuration that acts to separate the head from the tool. Often the head configuration includes an inclined ramp that allows the contact surfaces of the tool to disengage from the head. The disengagement process can result in the fastener head being stripped or damaged such that the fastener cannot be either driven further into the substrate or be removed from the substrate. In addition, the disengagement often results in the tool suddenly losing contact with the fastener such that the tool user cannot maintain control of the tool and/or associated driving device.

The environments in which the fasteners are deployed often exacerbate the above discussed drawbacks. For example, during construction, fasteners are often required to be used on portions of a structure which are not readily accessible. These structural portions may be positioned in an elevated, partially occluded, overhead, and/or in an orientation relative to the fastener installer such that the tool/fastener alignment as well as the pressure between the tool and fastener cannot be consistently maintained. For example, when a tool user is positioned on a ladder or scaffold in order to drive a fastener, the user often has to apply pressure on the tool driver with an arm that is extended laterally away from the body center. At the same time, the user must take care to remain in a stable and balanced position. This situation prevents a typical user from being able to apply as much force on the power driver as would be possible if the arm alignment was directly in front of the body center. This often results in the fastener head being stripped and/or the tool becoming disengaged with the fastener. When this disengagement occurs rapidly, the tool user often must quickly react in order to maintain stability to prevent falling from the ladder or scaffold.

### SUMMARY OF THE INVENTION

The present invention in a preferred form is directed to a fastener having a torque receiving head with an engagement surface that includes at least eight separate points of engagement. The points of engagement are arranged on eight radial slots formed about a central axis of the fastener head. The eight radial slots may have wall portions which collectively define a substantially square opening. The substantially square opening may provide an engagement location for a square bit tool. The radial slots may also have angled wall portions, wherein a portion of the wall has an angle defined between a lower portion of the wall and a top portion of the wall and which is relative to the central axis of the fastener head. The radial slots may be formed about the central axis of the fastener head such that each of the eight radial slots about the center axis have a center line, wherein each radial slot center line is indexed at an approximately 45° angle from an adjacent center plane. The positioning of the radial slots may allow tools of differing configurations to be used.

An object of the present invention is to provide a strong contact interface between the engagement portion of the fastener head and the driver tool during installation of the fastener.

An object of the invention is to provide a fastener with drive engagement surface which can be used with a variety of driver bits or fastener driver tools.

An object of the invention is to provide a method of forming a drive engagement surface with a die which provides a strong contact interface between the drive engagement portion of the fastener head and the driver tool during installation of the fastener.

A further object of the invention is to provide a fastener with a drive engagement surface which provides safe, efficient, and effective engagement with a driver tool.

### BRIEF DESCRIPTION OF THE DRAWINGS

Other objects and advantages of the invention will be evident to one of ordinary skill in the art from the following detailed description with reference to the accompanying drawings in which:

FIG. 1A shows a portion of a fastener engagement surface having radial slots which define a square opening consistent with the present invention;

FIG. 1B is a top view of a fastener head that includes a fastener engagement surface having radial slots which define a square opening consistent with the present invention;

FIG. 2A shows a portion of a fastener engagement surface having radial slots which define tool engagement surfaces consistent with the present invention;

FIG. 2B is a top view of a fastener head that includes a fastener engagement surface having radial slots which define tool engagement surfaces consistent with the present invention.

FIG. 3A shows a portion of a fastener head of a drill type fastener that includes a fastener engagement surface having radial slots which define tool engagement surfaces consistent with the present invention;

FIG. 3B shows a portion of a drill type fastener that includes a head with a fastener engagement surface having radial slots which define tool engagement surfaces consistent with the present invention;

FIG. 4A shows a portion of a fastener head of a panel fastener that includes a fastener engagement surface having radial slots which define tool engagement surfaces consistent with the present invention;

FIG. 4B shows a portion of a panel fastener that includes a head with a fastener engagement surface having radial slots which define tool engagement surfaces consistent with the present invention;

FIG. 5A shows a portion of a fastener head of a roofing type fastener with a drill-point and a truss head that includes a fastener engagement surface having radial slots which define tool engagement surfaces consistent with the present invention;

FIG. 5B shows a portion of a roofing type fastener with a drill-point and a truss head that includes a head with a fastener engagement surface having radial slots which define tool engagement surfaces consistent with the present invention;

FIG. 6A shows a portion of a fastener head of a plastic lumber fastener that includes a fastener engagement surface having radial slots which define tool engagement surfaces consistent with the present invention;

FIG. 6B shows a portion of a plastic lumber fastener that includes a head with a fastener engagement surface having radial slots which define tool engagement surfaces consistent with the present invention;

FIG. 7A shows a portion of a fastener head of a gutter fastener that includes a fastener engagement surface having radial slots which define tool engagement surfaces consistent with the present invention;

FIG. 7B shows a portion of a gutter fastener that includes a head with a fastener engagement surface having radial slots which define tool engagement surfaces consistent with the present invention;

FIG. 8A shows a portion of a fastener head of an engineered wood fastener that includes a fastener engagement surface having radial slots which define tool engagement surfaces consistent with the present invention;

FIG. 8B shows a portion of an engineered wood fastener that includes a head with a fastener engagement surface having radial slots which define tool engagement surfaces consistent with the present invention;

FIG. 9A shows a portion of a fastener head of a ledger board fastener that includes a fastener engagement surface having radial slots which define tool engagement surfaces consistent with the present invention;

FIG. 9B shows a portion of a ledger board fastener that includes a head with a fastener engagement surface having radial slots which define tool engagement surfaces consistent with the present invention;

FIGS. 10A-10C respectively show side perspective, front end, and side views of a fastener engagement tool consistent with the present invention;

FIG. 11 shows a portion of a fastener engagement surface having radial slots which define tool engagement surfaces consistent with the present invention;

FIG. 12A is a side view of a fastener engagement surface forming punch surfaces consistent with the present invention;

FIG. 12B is an enlarged side view of the fastener engagement surface forming punch of FIG. 12A showing the angled shoulder consistent with the present invention;

FIG. 13 is an enlarged top view of the fastener engagement surface forming punch of FIG. 12A showing the angled shoulder consistent with the present invention;

FIG. 14A shows a portion of a fastener head of a wood insulation screw fastener that includes a fastener engagement surface having radial slots which define tool engagement surfaces consistent with the present invention; and

FIG. 14B shows a portion of a wood insulation screw fastener that includes a head with a fastener engagement surface having radial slots which define tool engagement surfaces consistent with the present invention.

### DESCRIPTION OF THE PREFERRED EMBODIMENT

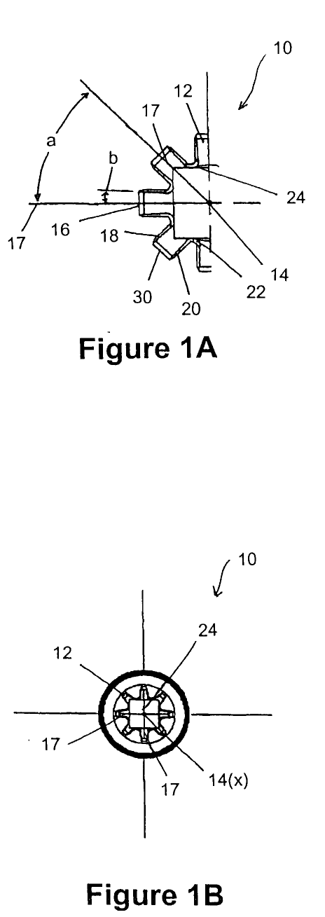

With reference to the drawings wherein like numerals represent like parts throughout the several figures, a fastener engagement surface formed in the head of a fastener in accordance with the present invention is generally designated by the numeral 10. The fastener engagement surface 10 includes, as partially shown in FIG. 1A and as shown in FIG. 1B, the walls of at least eight radial slots 12 spaced about a center axis 14 of the engagement surface 10.

In one embodiment of the present invention, each radial slot 12 includes a rear wall 16, a first side wall 18, and a second side wall 20. A radial slot center plane 17 extends from the center axis 14 of the engagement surface 10 through a point substantially equidistant from the positions where the rear wall 16 and the first side wall 18 intersect, and where the rear wall and the second side wall 20 intersect. The first side wall 18 of a first radial slot 12 and the second side wall 20 of a second adjacent radial slot 12 includes a transition portion 22. The transition portion 22 extends between adjacent radial slots 12.

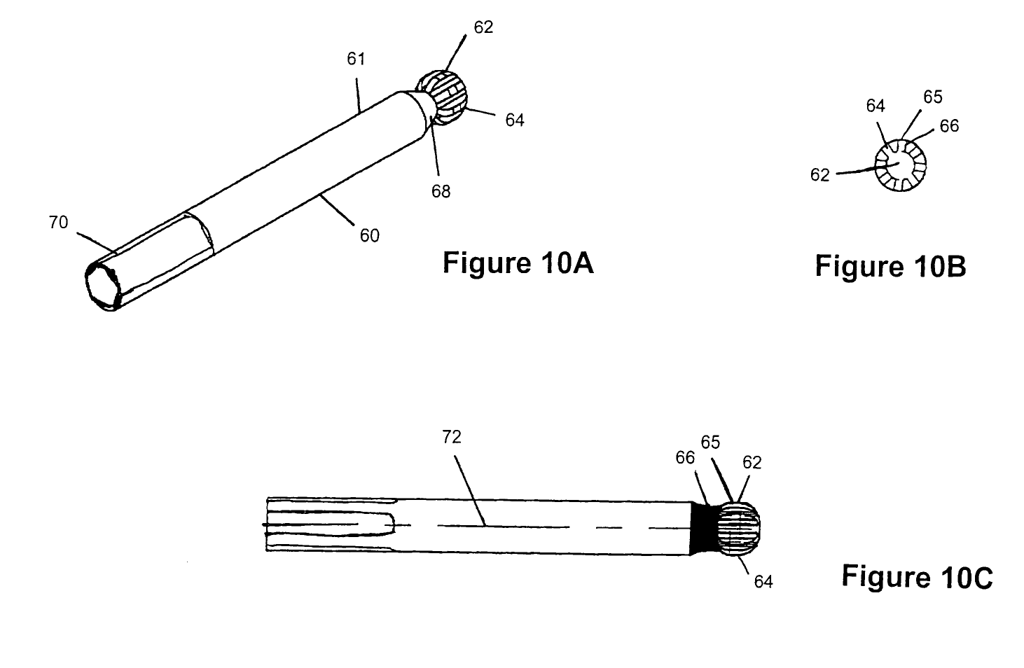

In one embodiment of the present invention, the first side wall 18 and second side wall 20 may be angled relative to the radial slot center plane 17. For example, an angle, shown in FIG. 1A as “b”, may be approximately 0° to approximately 4°, with a preferred angle being approximately 3°. The angle b, among other things, operates to enhance contact between the side wall and a drive tool 60 (FIGS. 10A-10C) and thus engagement with the engagement surface 10. For example, the tool may have features which are configured to be complementary to the angled side walls (16, 18) such that a close mechanical relationship is formed between the side walls (16, 18) and the tool features. This can reduce or prevent such things as slippage between the tool 60 and the engagement surface 10 and/or stripping of the engagement surface 10. The angled side wall may allow the engagement surface 10 to be connected to the tool such that a fastener essentially forms an extension of the tool. For example, the tool can be inserted into the engagement surface and the tool and fastener assembly can be moved as a unit to a site of installation.

In one embodiment of the present invention, portions of the radial slots 12 form an opening 24 which can be used to accept a fastener engagement tool 60. For example, as shown in FIGS. 1A and 1B, the relative positioning of the radial slots 12 and the transition portions 22 define a socket 24 which is substantially square in shape. It should be understood that, even though a socket 24 configured to receive a fastener driver tool is present, a fastener driver tool can also be used which has projections that operatively engage with some or all the radial slots 12.

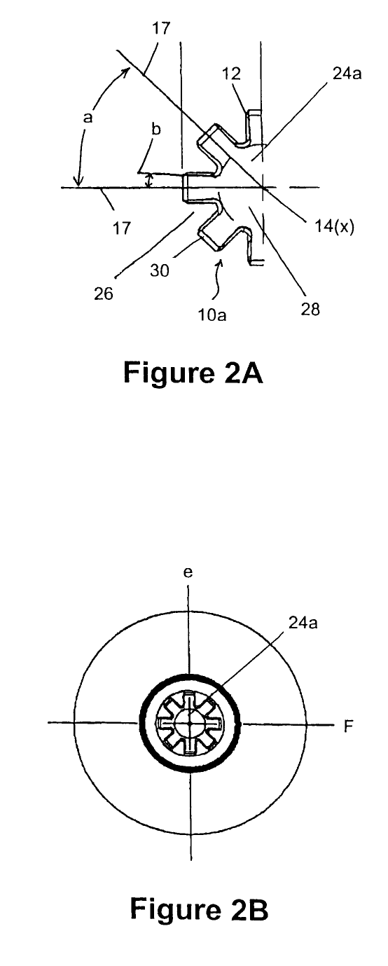

In one embodiment of the present invention, as shown in FIGS. 2A and 2B, the opening 24a of the fastener tool engagement surface 10a can be substantially round.

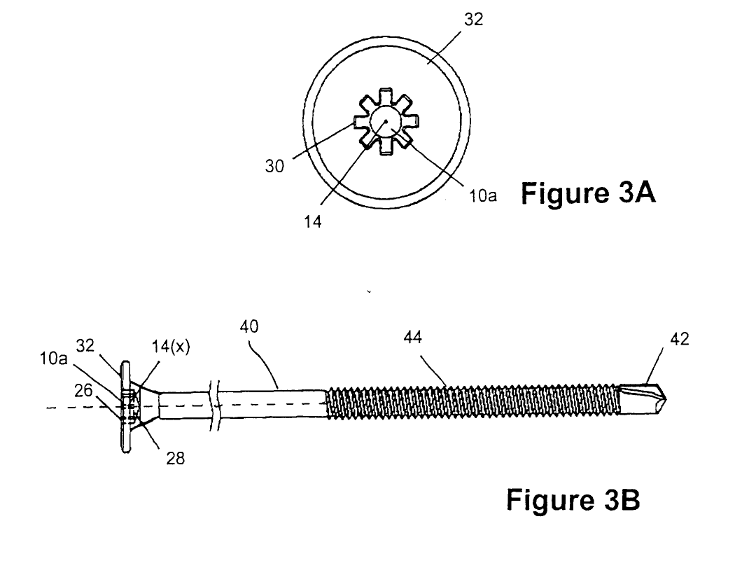

In one embodiment of the present invention, as shown in FIG. 3B, the engagement surface 10a has an upper portion 26 and a lower portion 28. As shown in FIG. 2A, the rear wall 16 and side walls 18, 20 of the radial slot 12 have portions which are angled relative to an axis “x” that extends through the central axis 14 of the engagement surface 10a. The angle of portions of the rear wall 16 and side walls 18, 20 may be in a range of between about 0° and about 5°. Preferably the angle is about 3° to about 4°. For example, portions of the rear wall 16 are angled such that a portion of the rear wall proximate the lower portion 28 is positioned closer to the axis “x” than a portion of the rear wall 16 proximate the upper portion 26. The angle of the rear wall 16 thus forms a bevel 30. The bevel 30 formed by the angle of the rear wall 16 and the side walls 18, 20, among other things, advantageously facilitates the insertion of the tool into the engagement surface 10a.

In one embodiment of the present invention, as shown in FIG. 1A, each radial slot 12 may be positioned such that the radial slot center plane 17 of adjacent radial slots 12 are indexed about the center axis 14 in 45°increments. For example, as shown in FIG. 1B, for a fastener engagement surface 10 having eight radial slots, the radial slots would be at the 0°, 45°, 90°, 135°, 180°, 225°, 270°, and 315°positions relative to the center axis 14. As shown in FIG. 2B, line “e” extends through radial slots 12 at the 0° and 180° positions, and line “f” extends through the radial slots 12 at the 90° and 270° positions. A tool can be utilized which, for example, engages with radial slots 12 at the 0° and 180° positions and/or radial slots 12 at the 90° and 270° positions. A tool can also be utilized which, for example, engages with radial slots 12 at any two or more of the 0°, 45°, 90°, 135°, 180°, 225°, 270°, and 315° positions.

As shown in FIGS. 3A and 3B, in one embodiment of the present invention, a fastener 40 may be used which has a head 32 with a fastener engagement surface 10a. The fastener 40 may be used for wood fastening and includes a drill type point 42 with a threaded region 44 proximate the drill type point 42.

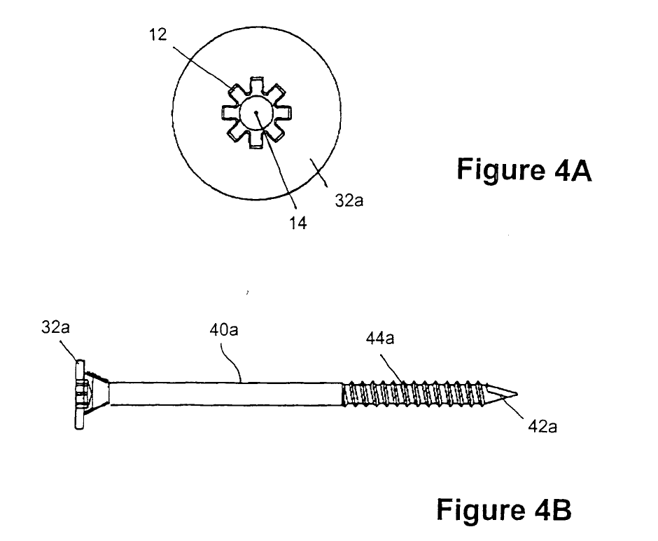

As shown in FIGS. 4A and 4B, in one embodiment of the present invention, a fastener 40a may be used which has a head 32a with a fastener engagement surface 10a. The fastener 40a may be used for fastening panel material and includes a fast entry type point 42a with a threaded region 44a proximate the fast entry type point 42a.

In FIGS. 3B and 4B, the underside of the head uniformly tapers toward the shaft at a preferred angle of 40°.

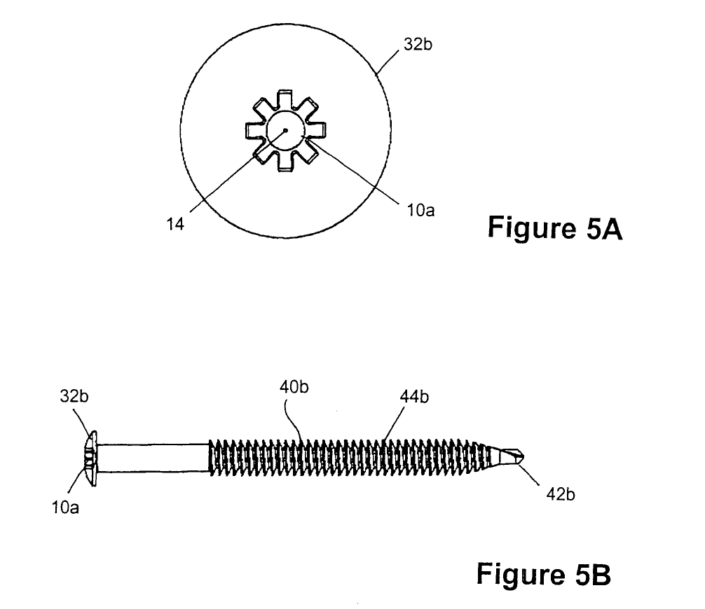

As shown in FIGS. 5A and 5B, in one embodiment of the present invention, a fastener 40b may be used which has a domed head 32b with a fastener engagement surface 10a. The fastener 40b may be used for roofing material fastening and includes a modified drill type point 42b with a threaded region 44b proximate the modified drill type point 42b.

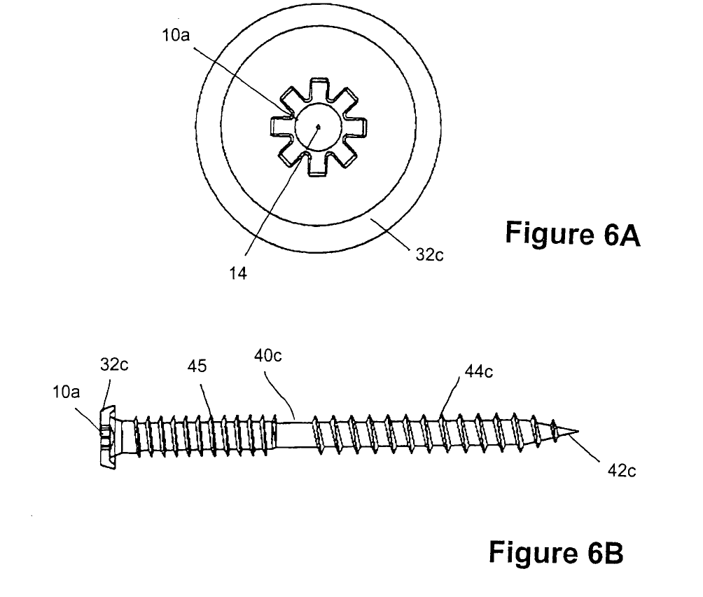

As shown in FIGS. 6A and 6B, in one embodiment of the present invention, a fastener 40c may be used which has a head 32c with a fastener engagement surface 10a. The fastener 40c may be used for plastic lumber fastening and includes a point 42c with a first threaded region 44c proximate the point 42c and a second threaded region 45 proximate the head 32c.

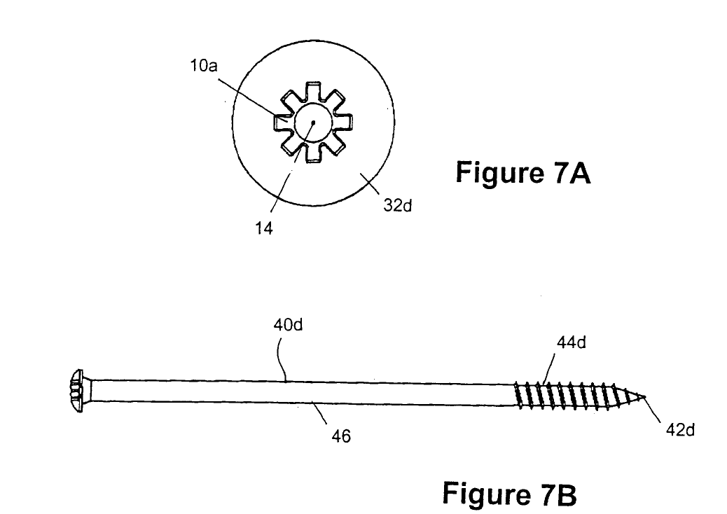

As shown in FIGS. 7A and 7B, in one embodiment of the present invention, a fastener 40d may be used which has a raised head 32d with a fastener engagement surface 10a. the fastener 40d may be used for fastening gutters to building structures and includes a point 42d with a threaded region 44d proximate the point 42d and an extended shaft region 46 intermediate the head 32d and the threaded portion 44d.

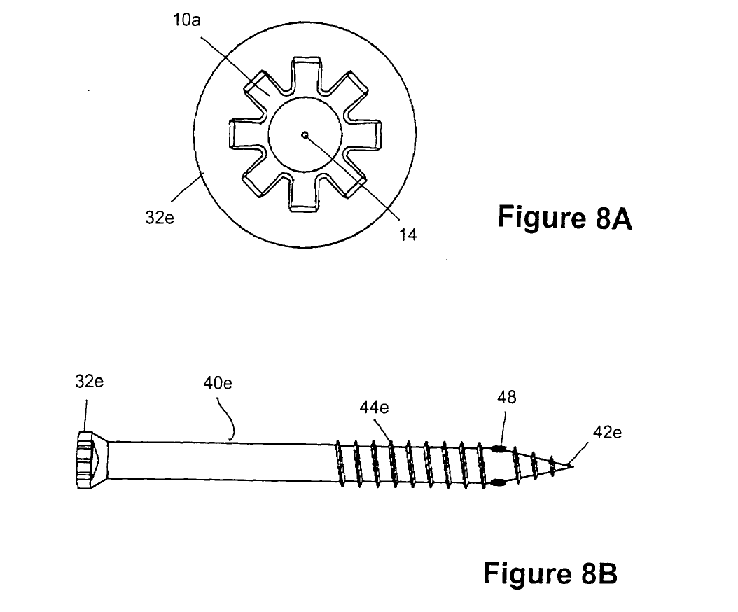

As shown in FIGS. 8A and 8B, in one embodiment of the present invention, a fastener 40e may employ a head 32e with a fastener engagement surface 10a. The fastener 40e may be used for engineered wood fastening and includes a point 42e with a threaded region 44e proximate the point 42e and includes spur elements 48 used to aid in fastening engineered wood.

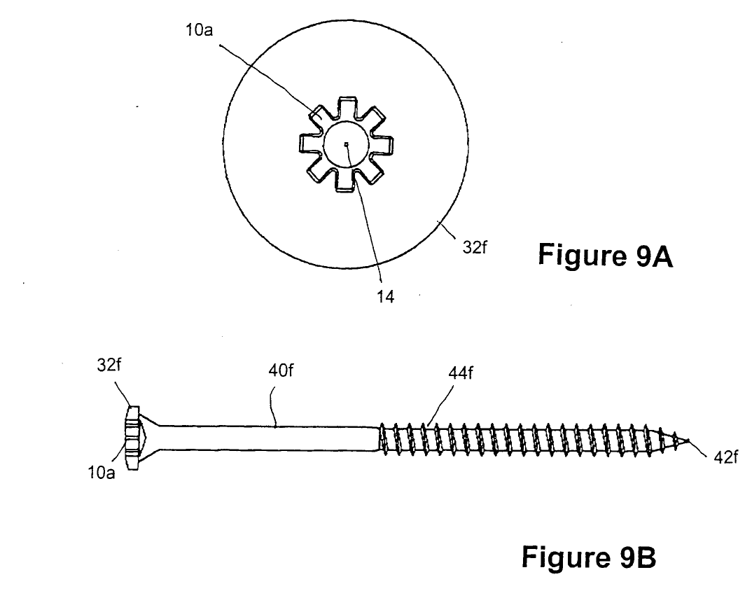

As shown in FIGS. 9A and 9B, in one embodiment of the present invention, a fastener 40f may be used which has a slightly radiused head 32 with a fastener engagement surface 10a. The fastener 40e may be used for fastening ledgers to building structures and includes a point 42f with a threaded region 44f proximate the point 42f.

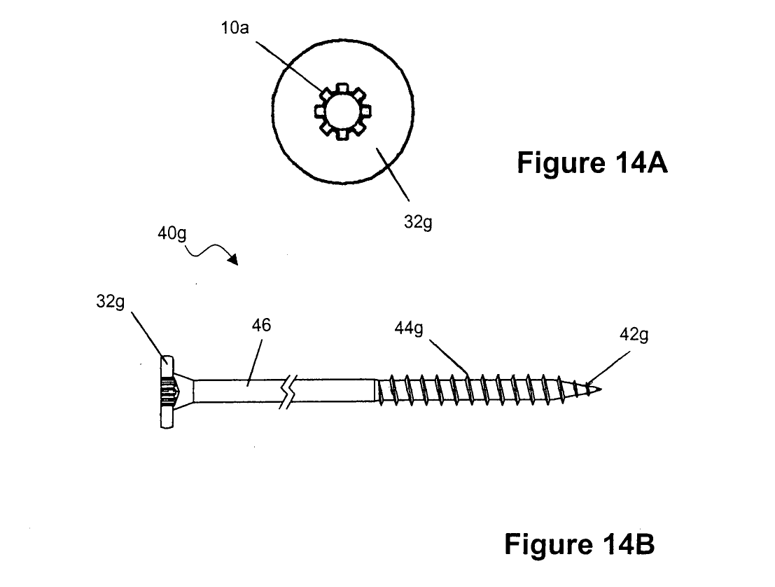

As shown in FIGS. 14A and 14B, in one embodiment of the present invention, a wood insulation screw 40g may be used which has a raised head 32g with a fastener engagement surface 10a. The fastener 40g includes a gimlet point 42g with a threaded region 44g proximate the point 42g and an extended shaft region 46 intermediate the head 32g and the threaded portion 44g. the lengths may range from 6.0 to 14.0 inches. The thread region 44g preferably extends 2.0 inches and the vertex point ranges from 25° to 30°.

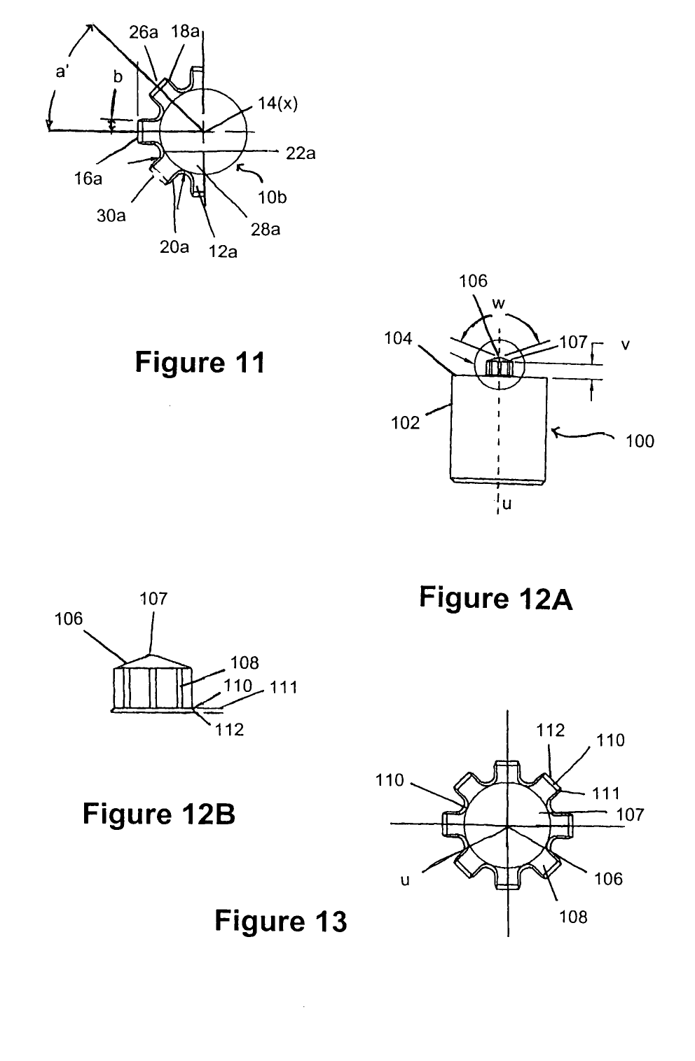

As shown in FIG. 11, in one embodiment of the invention, the fastener engagement surface 10b has an upper portion 26a and a lower portion 28a. The rear wall 16a and/or side walls 18a, 20a of the radial slot 12a have portions which are angled relative to an axis “x” that extends through the central axis 14 of the engagement surface 10b. The angle of portions of the rear wall 16a and/or side walls 18a, 20a may be in a range between about 0° to about 2°. Preferably the angle is about 0° to about 1°. For example, portions of the rear wall 16a and/or side walls 18a, 20a are angled such that a portion of the rear wall proximate the lower portion 28a is positioned closer to the axis “x” than a portion of the rear wall 16a proximate the upper portion 26a. The angle of the rear wall 16a and/or side walls 18a, 20a thus forms a bevel 30a. The bevel 30 formed by the angle of the rear wall 16a and/or side walls 18a, 20a, among other things, advantageously facilitates the insertion, engagement, and/or retention of the tool into the engagement surface 10b. It should be noted that the transition portion 22a between the radial slots 12a may also have an angled portion similar to the angled portion of the rear wall 16a and/or side walls 18a, 20a.

In one embodiment of the invention, as shown in FIGS. 10A-10C, a fastener engagement tool 60 includes a drive head 62 having splines 64. The drive head 62 may be rounded wherein head 62 is radiused convexly such that the head 62 has a substantially spherical configuration. The splines 64 are, in one embodiment of the invention, configured such that they extend outwardly from the head 62 and have an upper surface 65 which follows the radiused countour of the head 62. The splines have sides 66 which are configured to engage with a fastener tool engagement surface 10a, 10b such that lateral rotational force can be exerted on the engagement surface 10a, 10b.

The drive head 62, in one embodiment of the invention, is fixed to a shaft 61 of the fastener engagement tool by a neck region 68. The shaft 61 may have flattened areas 70 at one end. The flatted area 70, among other things, prevents the tool from slipping in, for example, a power tool (not shown) and/or allow the fastener engagement tool 60 to be attached to a hex driver (not shown).

In one embodiment of the invention, the fastener engagement tool 60 has a center axis 72 which extends longitudinally along the shaft 61 and head 62, as shown in FIG. 10C. When the fastener engagement tool 60 is engaged with the fastener engagement surface 10a, the fastener center axis 14 and the fastener engagement tool center axis 72 are in substantial angular alignment. However, the tool drive head 62, because of its substantially spherical configuration, allows for the fastener center axis 14 and the fastener engagement tool center axis 72 to be angled relative to one another and still be firmly engaged with the engagement surface 10. This flexible engagement geometry, for example, allows a longer fastener to be installed even when such a fastener has a slight bend. The flexible engagement also allows the fastener to be installed with a force that is sufficient to keep the head 61 and the engagement surface 10 mechanically engaged. This eliminates the need to apply additional force to a tool/fastener connection as required in conventional tool/fastener connections.

In one embodiment of the invention, the tool drive head 62 is fixed to the shaft by a neck region 68 which is radiused, as shown in FIG. 10C. The radiused neck allows the fastener center axis 14 and the fastener engagement tool center axis 72 to be angularly misaligned relative to one another such that the shaft 61 does not contact portions of the fastener head 32.

As shown in FIG. 12A, one embodiment of the present invention includes a fastener engagement surface forming punch 100. The punch 100 includes a body 102, which may be configured to be received by a punch holding tool (not shown). A working surface 104 is present at one end of the body 102 and includes a protrusion 106. The protrusion 106, as shown in FIG. 12, may include a substantially conical portion 107, flutes 108, and a profiled shoulder 110. The substantially conical portion 107 may be configured to facilitate the displacement of material as the punch 100 is brought into engagement with a surface. Advantageously, the conical portion 107 includes an angle “e” which is, for example, approximately 110° to approximately 160°. Preferably the angle “e” is approximately 140°.

As shown in FIG. 13, in one embodiment of the present invention, the flutes 108 are, for example, arranged about a center axis “u” of the protrusion 106. The flutes 108 have a configuration such that when engaged with a surface of a fastener, a fastener engagement surface 10, 10a, 10b is formed. For example, the flutes 108 may be arranged about the center axis “u” of the protrusion 106 such that when the center axis “u” is aligned with the center axis “x” of the fastener and the punch 100 is engaged with the fastener, the radial slots 12, 12a are formed.

As shown in FIG. 12B, in one embodiment of the present invention, the protrusion 106 includes the profiled shoulder 110 which is configured to form the beveled structure 30, 30a in the fastener engagement surface 10, 10a, 10b, when the punch 100 is engaged with the fastener. The profiled shoulder 110 includes a lower interface 112 which is proximate the punch body 102, and an upper interface 111 which is distal to the punch body 102. The profiled shoulder 110 may be present on the protrusion 106 such that when the center axis “u” is aligned with the center axis “x” of the fastener and the punch 100 is engaged with the fastener, angled portions are formed in at least one of the rear wall 16a, first side wall 18a, second side wall 20a, or transition portion 22a in a range between approximately 0° to approximately 2°. Preferably the angle is formed in the range of approximately 0° to approximately 1°.

While the embodiments of the foregoing invention have been set forth for the purpose of illustration, the foregoing description should not be deemed a limitation of the invention herein. Accordingly, various modifications adaptations and alternatives may occur to one skilled in the art without departing from the spirit and scope of the present invention. Accordingly, it is to be understood that the present invention has been described by way of illustration and not limitation.

1. A fastener having a drive head with a drive engagement surface, said drive engagement surface defined by:
at least eight slots positioned radially about a center axis of said fastener, each radial slot including a rear wall, a first side wall, and a second side wall; and
a slot center plane extending radially out from the center axis such that the radial slot center plane substantially bisects the radial slot rear wall.

2. The fastener of claim 1, wherein the first and second side walls are angled relative to the center radial slot plane.

3. The fastener of claim 2, wherein the angle between first and second side walls relative to the center radial slot plane is approximately 3°.

4. The fastener of claim 1, wherein the center radial slot plane of each of the eight radial slots is radially separated from an adjacent radial slot by an angle of approximately 45°.

5. The fastener of claim 1, wherein the rear wall has a first portion proximate a lower of the engagement surface and second portion proximate the upper portion of the engagement surface, said second end being angled outwardly relative to the center axis.

6. The fastener of claim 1, wherein the first side wall, the second side wall, and the rear wall have an upper and a lower portion, a segment extending between the upper and lower portions of the first and second side walls is angled relative to the center radial slot plane such that a distance from the center radial slot plane to each of the upper portions of the first and second side walls is greater than a distance from the center radial slot plane to each of the lower portions of the first and second side walls, and a segment extending between the upper and lower portions of the rear wall is angled relative to the center axis such that a distance from the center axis to the upper portion of the rear wall is greater than a distance from the center axis to the lower portion of the rear wall.

7. The fastener of claim 5, wherein the first and second side walls have an angle of approximately 0° to approximately 1°.

8. The fastener of claim 6, wherein the first and second side walls have an angle of approximately 0° to approximately 4° relative to the center radial slot plane.

9. The fastener of claim 6, wherein the first and second side walls have an angle of approximately 3° relative to the center radial slot plane.

10. The fastener of claim 6, wherein the rear wall has an angle of approximately 0° to approximately 5° relative to the center axis.

11. The fastener of claim 6, wherein the rear wall has an angle of approximately 3° to approximately 4° relative to the center axis.

12. The fastener of claim 1, wherein the center radial slot plane of each of the radial slots are respectively at an angular position of 0°, 45°, 90°, 135°, 180°, 225°, 270°, and 315° relative to the center axis.

13. The fastener of claim 1, wherein the radial slots are radially positioned so as to form a substantially square recess, said square recess having center coincident with the central axis.

14. The fastener of claim 8, wherein the square recess is configured to receive a substantially square drive tool.

15. A fastener having a head and a tool head assembly comprising:
a drive engagement surface formed in said head which includes at least eight radial slots positioned radially about a center axis, the radial slots including a rear wall, a first side wall, and a second side wall, and a radial slot center plane extending radially out from the center axis such that the radial slot center plane substantially equally bisects the radial slot rear wall; and
a tool head having driver surfaces in contact with portions of at least two of the radial slots.

16. A method of forming a drive engagement surface in a fastener head comprising:
providing a forming punch having a body, a working surface which includes a protrusion, said protrusion having a substantially conical portion, and at least eight flutes arranged about an axial center of the punch, said profiled shoulder including a lower interface proximate the punch body and an upper interface proximate the punch body, wherein the lower interface is a greater distance from the axial center of the punch than the upper interface;
aligning the axial center of the punch with an axial center of a fastener workpiece;
contacting the punch with the fastener workpiece;
forcing the punch and fastener workpiece together wherein the punch protrusion displaces fastener material such that at least eight radial slots are formed; and
applying force between the punch and fastener workpiece until the lower interface is proximal the fastener such that an angled portion is formed in at least one of a rear wall, a first side wall, a transition portion, or a second side wall of the radial slots.

17. The method of forming a drive engagement surface of claim 16, further including the step of creating an angular orientation between a first side wall and a second side wall of each radial slot relative to a center radial slot plane of each slot.

18. The method of forming a drive engagement surface of claim 17, wherein the angular orientation is in a range of approximately 0° to approximately 4°.

19. The method of forming a drive engagement surface of claim 16, wherein the angled portion formed in at least one of the rear wall, the first side wall, the transition portion, or the second side wall of the radial slots is in the
